(19) United States
(12) Patent Application Publication
(10) Pub. No.: US 2015/0179087 A1
(43) Pub. Date: Jun. 25, 2015

(54) MOBILE-DEVICE INSTIGATED FACILITATION OF USER-ENVIRONMENT INTERACTION

(71) Applicant: Google Inc., Mountain View, CA (US)

(72) Inventors: Charles CHEN, San Jose, CA (US); Tiruvilwamalai venkat RAMAN, San Jose, CA (US); Alan VIVERETTE, Mountain View, CA (US); Casey BURKHARDT, Mountain View, CA (US); Aman GOVIL, San Francisco, CA (US)

(73) Assignee: Google Inc., Mountain View, CA (US)

(21) Appl. No.: 14/134,647

(22) Filed: Dec. 19, 2013

(51) Int. Cl. G09B 21/00; G06K 7/10; G08B 21/18

(52) U.S. Cl. CPC G09B 21/00; G08B 21/18; G06K 7/10297

(57) ABSTRACT

Embodiments of the invention are generally drawn towards facilitating interaction between a user and the environment in which the user is located. Embodiments of the invention contemplate the collection of information pertaining to an environment in which a user affiliated with a client device is located and the analysis of such information in the service of facilitating user-environment interaction. Embodiments of the present invention may trigger a particular output comprehensible to a user wherein the particular output is determined by the information collected from the environment. Embodiments of the invention may also trigger a modification to the environment through communication with elements within the environment wherein the particular modification is determined by information corresponding to a user and the user's environment.

### BACKGROUND

The number of users of mobile computerized devices has increased dramatically in recent years. The compact size of such devices enables users to carry them nearly constantly. Furthermore, as the number of interconnected devices has grown, the variety of potential interactions and the amount of information available through the use of such devices have increased dramatically. The proliferation of mobile devices have drawn large numbers of additional individuals into becoming computerized device users.

Also in recent years, the cost of sensors capable of storing information and being embedded in the environment, such as NFC tags, has decreased while the capabilities of such sensors have expanded significantly. The ability of mobile devices to communicate with such sensors and thereby connect objects within the physical environment to the internet has resulted in a dramatic increase in the population of the “internet of things.”

### SUMMARY

Embodiments of the invention provide a means for augmenting the biological senses of users and may be particularly beneficial for users whose sensory perceptions are degraded or impaired with respect to the sensory perceptions of a majority of users. In particular, embodiments of the invention provide systems and methods for interaction between a user, a client device, and the user's surroundings or environment. Embodiments of the invention thereby facilitate interactions between a user and the user's environment.

One implementation is a method, implemented at a client comprising a processor, for providing a response to information representative of the surroundings of the client, the method comprising acquiring the information representative of the physical surroundings of the client device, analyzing the information representative of the physical surroundings, and initiating a user-intelligible output in response to the analyzing, wherein the information representative of the physical surroundings of the client device is transmitted to the client by a wearable short-range wireless communication (SRWC) initiator, and wherein the analyzing determines the characteristics of the output.

Another implementation is a system for providing a response to information representative of the surroundings of a client, the system comprising, a wearable short-range wireless communication (SRWC) initiator, configured to acquire information representative of the surroundings of the client, and transmit the information representative of the surroundings of the client to the client, and a client comprising a processor configured to provide a response to information representative of the surroundings of the client, acquire the information representative of the physical surroundings of the client device, analyze the information representative of the physical surroundings, and initiate a user-intelligible output in response to the analyzing.

### BRIEF DESCRIPTION OF THE DRAWINGS

FIG. 1 is a block diagram of an example environment in which the methodology for automatically facilitating user interaction with the user's present environment may be implemented;

FIG. 2 is a block diagram of the basic functional components for an example client device depicted in FIG. 1, according to one aspect of the disclosure;

FIG. 3 is a block diagram of the basic functional components for a user-environment interaction server depicted in FIG. 1, according to one aspect of the disclosure;

FIG. 4 is a flow diagram illustrating an example method, implemented at a client device, for short range wireless communication target data triggered facilitation of user interaction with the user's environment;

FIG. 5 is a flow diagram illustrating an example method, implemented at a client device, for configuring a user's environment wherein the automatic configuration is triggered by the receipt of data stored at a short range wireless communication target.

FIG. 6 is a flow diagram illustrating an example method, implemented at a client device, for providing indoor navigation services to a user;

FIG. 7 is a flow diagram illustrating an example method, implemented at a client device, for facilitating interaction between a user and a retail environment.

### DETAILED DESCRIPTION

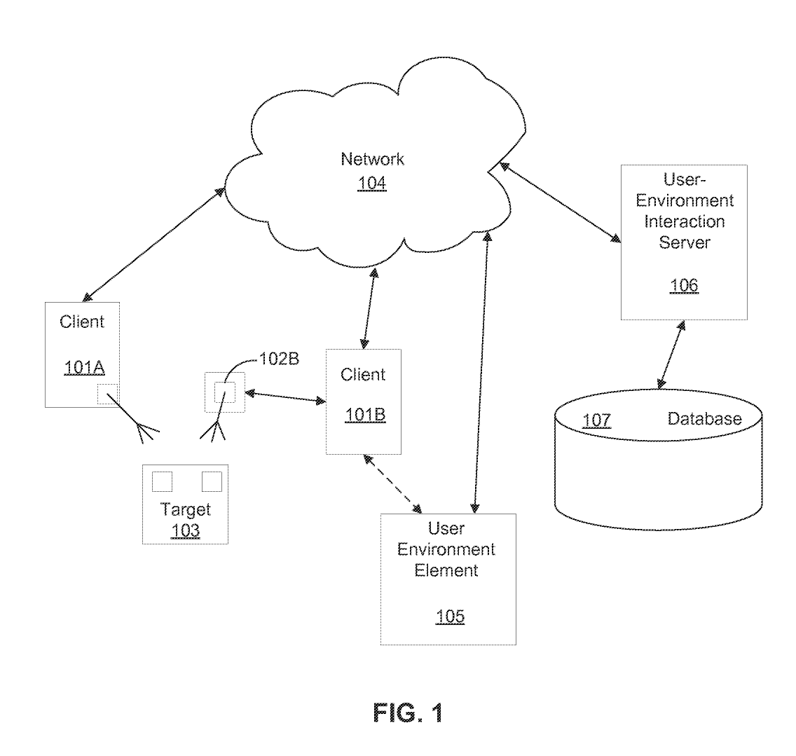

FIG. 1 is a block diagram of an example environment in which methodologies for facilitating user interaction with the user's present environment may be implemented. In the example environment depicted in FIG. 1, client devices 101A and 101B are connected to a network 103. Client device 101B is equipped with a short range wireless communication (SRWC) initiator 102B that enables the client device 101A to acquire information from SRWC targets, such as target 103. Client device 101A is also able to acquire information from SRWC targets but does so through an integrated SRWC initiator. The client device 101B acquires information from SRWC initiator 102B via a communicative connection between the client device 101B and the SRWC initiator 102B.

The clients 101A and 101B are connected, via a data network 104, to a user environment element 105 and a user-environment interaction server 106. The user-environment interaction server 106 manages a multitude of user accounts, receives requests from clients pertaining to user account data, and transmits user account data to clients. The user-environment interaction server 106 is further connected to a database 107. Database 107 stores a variety of information pertaining to user accounts managed by the user-environment interaction server 106. The user environment element 105 may be any device in a user's environment capable of connecting to a data network such as the data network 104 and of either sending, receiving, or both sending and receiving data over the data network 104.

Client devices 101A and 101B may be any of a smart phone, a personal digital assistant (PDA), a tablet computer, a wearable computer, a laptop computer, a video-game console, or any one of a number of additional devices that may establish communicative connections with other devices over a network. Client devices 101A and 101B are capable of sending information to and receiving information from the user-environment interaction server 106 and the user environment element 105. For example, client devices 101A and 101B may request and receive data pertaining to a particular user account from the user-environment interaction server 106 and may transmit a configuration request with accompanying configuration data to the user environment element 105. Client 101A is equipped with an integrated SRWC initiator.

The initiator 102B establishes communicative connections with the target 103 when brought into close proximity of the target 103. The target 103 may include a single SRWC element or may include multiple SRWC elements (such as the two tags depicted in FIG. 1). The communicative connections established by the initiator 102B with the target 103 may adhere to a near field communications (NFC) protocol or may adhere to a variety of other SRWC protocols. The initiators 102A and 102B may also act as an SRWC target in implementations where the target 103 is capable of both active and passive SRWC modes. The initiator 102B may be a component of a wearable article, e.g. a shoe, a watch, a glove, a ring, etc. The initiator 102B may further be designed to perform initiation of targets, such as target 103, that are embedded in a user's environment during the course of the user's natural interactions with the environment.

SRWC targets, such as the target 103, may be both active and passive SRWC targets and may include but are not limited to tags, cards, stickers, and fobs equipped with an SRWC target. SRWC targets may be embedded in the environment, such as underneath the floor of a particular building, and may also be attached to or embedded within an item of interest, such as an article of merchandise in a store. In various implementations, the target 103 may be connected to the user environment element 105 through a communicative connection. In such implementations where the target 103 is also capable of active and passive modes of communication, the clients 101A and 101B may transmit data to the user environment element 105 without utilizing the network 104.

The network 104 connects the client devices 101A and 101B to the user environment element 105 and the user-environment interaction server 106. The network 104 may be either a wired or a wireless network, and may include elements of a cellular network, a voice over internet protocol (VoIP) network, a public switched telephone network (PSTN), or a combination thereof. Example networks include but are not limited to an LTE network, a GSM network, a CDMA network, a fiber optic network, and other voice or data networks. The network 104 may also include elements of WLAN or WPAN networks that enable the client devices 101A and 101B to connect to other components of the network, for example an LTE network. The network 104 may include a set of cell towers, as well as a set of base stations and/or mobile switching centers (MSCs). As appreciated by those skilled in the art, the network 104 may include various cell tower/base station/MSC arrangements. For example, a base station and a cell tower could be co-located at the same site or they could be remotely located, and a single base station could be coupled to various cell towers or various base stations could be coupled to a single MSC, to name but a few of the possible arrangements. Alternatively or in addition to the aforementioned components of the network 104, the network 104 may include one or more IP multimedia subsystems (IMS), serving gateways (SGW), and evolved node Bs (eNB). One of ordinary skill in the art will recognize that additional components not mentioned herein may be used by the network 104.

Configurable Environmental Element 105 may be any system, apparatus, appliance, or other entity with which a user can interact and with which a communicative connection, either direct or indirect, with a client can be established. Non-limiting examples of the configurable environmental element 105 include an automatic door, a speaker, an information kiosk, a vending machine, and a customer service center. For example, the configurable environmental element 105 may be a computerized device at a point of sale. The configurable environmental element may communicate directly with the client or may communicate with the client 101 through the server 106.

User-environment interaction server 106 comprises processors and memory configured to receive information from the client devices 101A and 101B and to provide information to the client devices 101A and 101B. The information received by the user-environment interaction server 106 may include data pertaining to a user account affiliated with a client device and data pertaining to contextual information relevant to a client device or to a user account affiliated with the client device. User-environment interaction server 106 may further comprise processors and memory configured to determine a course of action a user affiliated with a client device is likely to pursue based on a variety of contextual and environmental information available to the user-environment interaction server 106. Furthermore, user-environment interaction server 106 may be configured to transmit data pertaining to historical behavior of a user affiliated with a user account to one of the clients 101.

Processors and memory located at the user-environment interaction server 106 may also be configured to both access information stored at a database and to store information at a database, such as database 107. For example, user-environment interaction server 106 may be configured to store information pertaining to historical execution of actions by the client 101 under certain circumstances, and a variety of other information at the database 107. Furthermore, user-environment interaction server 106 may be configured to request data pertaining to one or more credentials linked to a user account or client from the database 107. Access to some information stored at databases may be limited and may require some form of authentication prior to access. For example, data associated with a particular user account may be limited pursuant to the settings of such user account, and user-environment interaction server 106 may only access such information under certain circumstances.

User-environment interaction server 106 is also connected to the database 107. The database 107 may store a variety of information, including, e.g., information pertaining to one or more user accounts. Information pertaining to the one or more user accounts may include but is not limited to a user account name, the name of a user to whom the user account belongs, an alias for the user account, verification information for the user account, a social network profile associated with the user account, images associated with the user account, documents and media content associated with the user account, and various user account settings. Furthermore, database 107 may also store a variety of data pertaining historical behavioral patterns affiliated with the user accounts. For example, data pertaining to actions taken by a client associated with a user account during particular circumstances may be stored at the database 107. Such actions may be representative of behaviors engaged in by a user of the client associated with the user under such circumstance.

Embodiments of the invention that may be practiced in the example environment represented by FIG. 1 are generally drawn towards facilitating the interaction between a user and the environment in which the user is located. Broadly speaking, embodiments of the invention contemplate the collection of information pertaining to an environment in which a user affiliated with a client device is located and the employment of such information, potentially in conjunction with related information, in the service of facilitating user-environment interaction. While the embodiments of the invention may be of maximum marginal utility to users who demonstrate impaired sensory perception or mobility relative to the majority of users, such embodiments may nevertheless be useful to those users with average or above average sensory perception.

Implementations of the present disclosure provide systems and methods for collecting information from a user's environment. The systems described in the present disclosure are capable of collecting and analyzing the environmental information in real time in order to facilitate a user's interaction with his current environment. The information collection may be performed by a client device, for example a smart phone, a tablet computer, and a wearable computer, e.g. a smart watch. The information collection may be performed directly by the client device, i.e. the client device gathers information about the environment directly from the environment itself without the assistance of an intermediary, or indirectly by the client device through an intermediary. The intermediary may be any device capable of establishing a communicative connection with the client device, e.g. an SRWC initiator such as an NFC interrogator. The SRWC initiator may collect information directly from the environment and transmit such information, or a representation of such information, to the client device.

In addition to the collection of information from the environment, implementations of the invention contemplate an analysis of the collected information. In various implementations, the analysis may be performed by a client device or by a server communicatively connected to the client device. The analysis may also be distributed across multiple devices that may include a client device, a server, and an information collection intermediary such as the SRWC initiator. The results of the analysis trigger a response, by the system components, to the particular information collected from the environment. The response includes the execution of further actions by the client device designed to facilitate user-environment interaction.

The analysis of the information collected from the environment may involve the use of the environmental information as an input into a processing routine or algorithm designed to determine an appropriate action or set of actions for facilitating user interaction with particular elements of the user's environment. Processing routines and algorithms may additionally utilize information obtained from a profile that corresponds to a client or to a user affiliated with the client. In some implementations, the specifics of the processing routines and algorithms may be dictated by a class representative of a client or a user affiliated with the client. For example, classes may be defined for hearing impaired users, for users with impaired vision, or for users with other physical disabilities. Such implementations provide different responses to the same information for different classes of users. For example, the detection of a door in the environment might trigger the transmission of a command to open the door if the client receiving the indication of the door were affiliated with a user without the physical capacity to open the door. Alternatively, the detection of a door might not trigger any response for a client affiliated with an impaired hearing class.

In various implementations, the response triggered by the collection and analysis of information may include providing output to a user, initiating a modification of the user's environment, collecting (and potentially recording) additional information related to the environmental information, and combinations thereof. The particular output may be dictated, at least in part, by a class corresponding to a particular user and the algorithms, rules, and processing routines established by that class. For example, in response to identical circumstances, a client might provide audible output to an individual having impaired vision and provide tactile output, such as a vibration, to an individual exhibiting impaired hearing.

Information that is collected from the environment may be stored for a period of time. The period of time for which the information is stored may be determined based upon the content of the information, the manner in which it was received, or some other attribute of the information or the information collection process. The systems and methods of the present invention may adjudge certain information to not be representative of the environment in which a user (or a proxy for the user, such as a client or wearable SRWC initiator) is currently present. Such information may be deemed stale. Stale information may be maintained in a computer readable storage device for a particular period of time if it is deemed to potentially be indicative of the characteristics of a user's present or future environment. Stale information may also be maintained if it is deemed to be potentially useful in ascertaining characteristics of a user's future environment.

Implementations of the present invention may also initiate a modification to the user's environment. For example, in response to receiving information indicating that a particular element is present in the environment, a communicative connection may be established between a client and the element. The communicative connection may be utilized by the client to cause the element to take a particular action or to produce a particular effect. The types of actions or effects initiated by the client can be determined by a result of an analysis, performed by the client or a server, of information received by the client from the environment. For example, a client affiliated with an individual exhibiting impaired vision may initiate output on a speaker located in the client's environment in response to detecting the presence of the speaker. In such implementations, the specifics of the action taken may be determined based upon an analysis of information associated with a user account, stored at a database, or provided by an application executed at the client or server. A modification to the user's environment may also consist of nothing more than providing output to the user.

In order to facilitate the interaction of the user with the user's environment, the locations and positions of client devices and wearable communication devices can be used to define the user's environment. In particular, elements in the vicinity of client devices and wearable communication devices may be deemed to be within the user's environment.

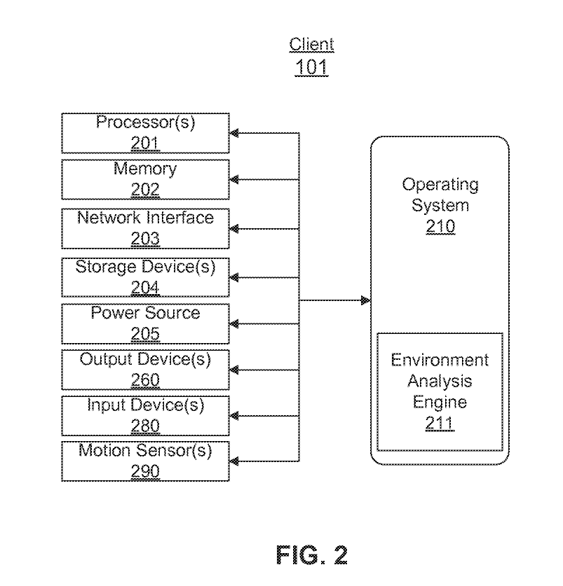

Turning now to FIG. 2, a block diagram of the basic functional components for an example client device of FIG. 1 is depicted. In general, many other embodiments of the client device 101 may be used as long as the embodiment is capable of receiving and transmitting data over one or more wireless interfaces. In the embodiment illustrated by FIG. 2, the client device 101 includes one or more processors 201, memory 202, a network interface 203, one or more storage devices 204, a power source 205, one or more output devices 260, one or more input devices 280, and one or more motion sensors 290. The client device 101 also includes an operating system 210 that is executable by the client 101, and further includes an environment analysis engine 211. In some implementations, the environment analysis engine 211 may be a component of the operating system 210 (as is depicted by FIG. 2). in alternative implementations, the environment analysis engine may be separate and distinct from the operating system 210 or may comprise elements of the operating system 210 as well as elements that are external to the operating system 210. In a conventional fashion, each of components 201, 202, 203, 204, 205, 210, 211, 260, 280, and 290 are interconnected physically, communicatively, and/or operatively for inter-component communications.

As illustrated, processors 201 are configured to implement functionality and/or process instructions for execution within the client device 101. For example, processors 201 execute instructions stored in memory 202 or instructions stored on storage devices 204. Memory 202, which may be a non-transient, computer-readable storage medium, is configured to store information within the client device 101 during operation. In some embodiments, memory 202 includes a temporary memory, i.e. an area for information to be maintained when the client device 101 is turned off. Examples of such temporary memory include volatile memories such as random access memories (RAM), dynamic random access memories (DRAM), and static random access memories (SRAM). Memory 202 also maintains program instructions for execution by the processors 201.

The client device 101 uses network interface 203 to communicate with external devices via one or more networks, such as the network 104 of FIG. 1. The network interface 203 may include multiple interfaces for connecting with various types of networks. Such networks may include one or more wireless networks, wired networks, fiber optics networks, and other types of networks through which communication between the client 101 and an external device may be established. Network interface 203 may include a network interface card, such as an Ethernet card, an optical transceiver, a radio frequency transceiver, or any other type of device that can send and receive information. Other non-limiting examples of interfaces that may be included in the network interface 203 include Bluetooth, 3G and WiFi radios as well as USB interfaces.

In reference to client 101A of FIG. 1, the network interface 203 also includes a short range wireless communication (SRWC) interface. Therefore, in the case of client 101A, the network interface 203 enables the client 101A to establish an SRWC connection with the target 103, with a separate client, or with any other device capable of establishing an SRWC connection. The network interface 203 may comprise an SRWC interface that enables short range communicative connections established according to near field communications (NFC) protocol. An SRWC interface that enables connections in accordance with NFC protocol may be referred to as an NFC interface. In reference to client 101B of FIG. 1, the network interface 203 includes a means through which communication with the SRWC initiator 102B may be established. Such interfaces may include but are not limited to any type of wireless personal area network (WPAN) interface.

Storage devices 204 also include one or more non-transient computer-readable storage media. Storage devices 204 are generally configured to store larger amounts of information than memory 202. Storage devices 204 may further be configured for long-term storage of information. In some examples, storage devices 204 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The client 101 includes one or more power sources 205 to provide power to the client. Non-limiting examples of power source 205 include single-use power sources, rechargeable power sources, and/or power sources developed from nickel-cadmium, lithium-ion, or other suitable material.

The client 101 includes one or more input devices 280. Input devices 280 are configured to receive input from a user through tactile, audio, and/or video feedback. Non-limiting examples of input device 280 include a presence-sensitive screen, a keyboard, a voice responsive system, a video camera, a microphone, and any other type of device for detecting a command from a user. In some examples, a presence-sensitive screen includes a touch-sensitive screen.

One or more output devices 260 are also included in client 101. Output devices 260 are configured to provide output to a user using tactile, audio, and/or video stimuli. Output device 260 may include a display screen (which may be part of a presence-sensitive screen), a sound card, a video graphics adapter card, or any other type of device for converting a signal into an appropriate form understandable to humans or machines. Additional examples of output device 260 include a speaker, a liquid crystal display (LCD), or any other type of device that can generate intelligible output to a user. The motion sensors 290 are configured to detect motion of the client 101. The motion sensors 290 may include but are not limited to accelerometers and gyroscopes.

The client 101 includes an operating system 210, such as the Android® operating system. The operating system 210 controls operations of the components of the client 101. For example, the operating system 210 facilitates the interaction of the processors 201, memory 202, network interface 203, storage device(s) 204, input device 280, output device 260, power source 205, and motion sensors 290.

The client 101 further includes an environment analysis engine 211. In various implementations the environment analysis engine 211 may be a component of the operating system 210, may comprise components of the operating system 210, or may be distinct from the operating system 210. The environment analysis engine 211 is configured with processor executable instructions. Such processor executable instructions may facilitate the interaction of the processors 201, memory 202, network interface 203, storage device(s) 204, output device 260, input device 280, and motion sensors 290. The environment analysis engine 211 is configured to receive information pertaining to an environment, to collect additional information pertaining to the context of the device within the environment, to analyze the totality of accumulated information, and to generate user output in response to the analysis.

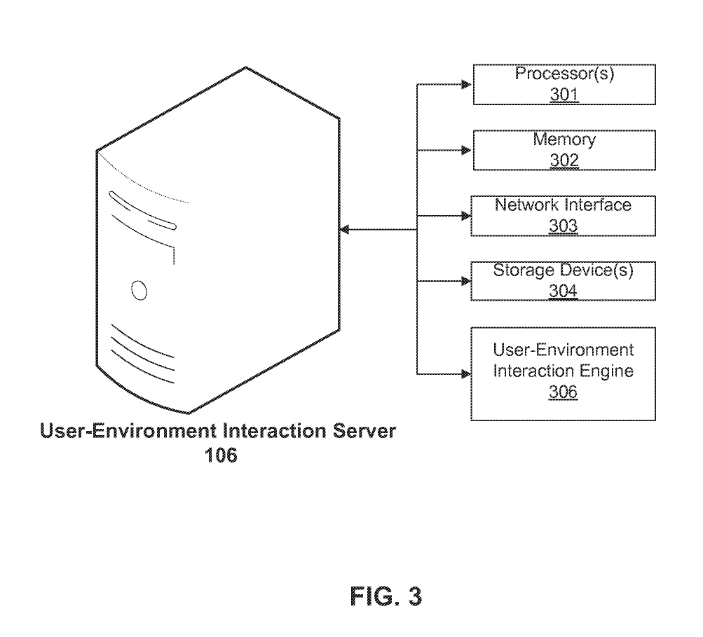

FIG. 3 is a block diagram of the basic functional components for the user-environment interaction server 103 depicted in FIG. 1, according to one aspect of the disclosure. The user-environment interaction server 300 includes one or more processors 301, memory 302, a network interface 303, one or more storage devices 304, and a user-environment interaction engine 305. In a conventional fashion, each of components 301, 302, 303, 304, and 305 are interconnected physically, communicatively, and/or operatively for inter-component communications.

As illustrated, processors 301 are configured to implement functionality and/or process instructions for execution within user-environment interaction server 300. For example, processors 301 execute instructions stored in memory 302 or instructions stored on storage devices 304. Memory 302, which may be a non-transient, computer-readable storage medium, is configured to store information within user-environment interaction server 300 during operation. In some embodiments, memory 302 includes a temporary memory, i.e. an area for information to be maintained when the user-environment interaction server 300 is turned off. Examples of such temporary memory include volatile memories such as random access memories (RAM), dynamic random access memories (DRAM), and static random access memories (SRAM). Memory 302 also maintains program instructions for execution by the processors 301.

Storage devices 304 also include one or more non-transient computer-readable storage media. Storage devices 304 are generally configured to store larger amounts of information than memory 302. Storage devices 304 may further be configured for long-term storage of information. In some examples, storage devices 304 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The user-environment interaction server 300 uses network interface 303 to communicate with external devices via one or more networks, such as the network 103 of FIG. 1. Such networks may include one or more wireless networks, wired networks, fiber optics networks, and other types of networks through which communication between the user-environment interaction server 300 and an external device may be established. Network interface 303 may be a network interface card, such as an Ethernet card, an optical transceiver, a radio frequency transceiver, or any other type of device that can send and receive information.

User-environment interaction engine 305 is configured to receive information pertaining to a the physical environment in the vicinity of the client 101. The user-environment interaction engine 305 may further be configured to analyze contextual information pertaining to a client or a user account affiliated with a client in order to determine a set of actions likely to be useful in facilitating interaction between the user and the user's environment. The user-environment interaction engine 305 may compute the likelihood that one or more actions are likely to be used under particular circumstances through a variety of algorithms that account for a variety of information that may be stored at the memory 302, the storage devices 304, or received through the network interface 303.

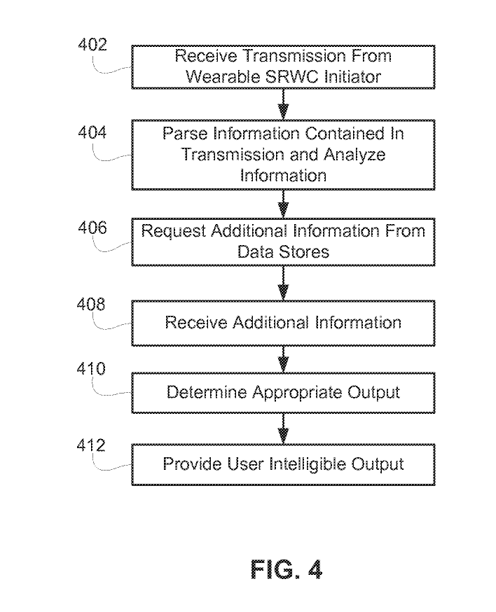

FIG. 4 is a flow diagram illustrating an example method, implemented at a client device, for short range wireless communication target triggered facilitation of user interaction with the user's environment. At 402, the client 101 receives a transmission from the SRWC initiator 102. The transmission received by the client 101 at 402 is responsive to the detection of a triggering event by the SRWC initiator 102. Triggering events may include but are not limited to the establishment of a SRWC connection with the target 103. Triggering events can trigger a transmission from the SRWC initiator 102 to the client 101.

In some implementations, the information received by the client 101 at 402 may be the same information that is stored at the target 103. In such implementations, the SRWC initiator 102 performs no translation of the information received via the SRWC connection with the target 103 and functions only as a passive intermediary. However, the SRWC initiator 102 may also analyze the content of the information received via the SRWC connection with the target 103 and perform an action in response to the analysis. The information stored at the target 103 may be representative of one of various syntactic paradigms that the SRWC initiator 102 is configured to recognize. In such implementations, the transmission sent at 402 by the SRWC initiator 102 may be dictated, at least in part, by the syntactic paradigm recognized by the SRWC initiator. The SRWC initiator 102 may also parse the information stored at the target 103 and analyze the semantic content of the information. In such implementations, the information transmitted to the client 101 at 402 may depend, at least in part, on the analysis performed by the SRWC initiator 102. The SRWC initiator 102 may also augment the content of the information stored at the at the target 103. In such implementations, the SRWC initiator transmits both the information stored at the target 103 and additional information produced by the SRWC initiator 102 as a result of an analysis of the information stored at the target 103.

At 404, the client 101 parses the information contained in the transmission received at 404 and analyzes the information. In alternative implementations, the parsing and analysis may be executed by the server 106 or the parsing and analysis operations may be distributed across the client 101 and the server 106. For example, various aspects of the analysis of the information may be performed by the client 101 while additional aspects of the analysis may be performed by the server 106. The client 101 may be configured with computer executable instructions that parse the information received from the SRWC initiator 102 and prescribe a particular course of action depending upon the semantic content of the information received at 402, the syntactic structure of the information received at 402, or a combination thereof. For example, the environment analysis engine 211 of the client 101 may parse and analyze the information received at 402.

The analysis performed by the client 101 and/or the server 106 may be dependent upon a classification of the client 101 or upon a classification of a user account affiliated with the client 101. Information pertaining to such classifications may be stored at the client 101, the server 106, or the database 107 in addition to alternative possibilities. The classification of the client 101 or the user account affiliated with the client 101 may be correspond to a particular impairment suffered by a user of the client 101 or by a user associated with the user account. Classifications may include, but are not limited to, visually impaired user, hearing impaired users, and mobility impaired users. The classification may provide rules, algorithms, and processing routines that dictate the response of the client 101, the server 106, and other components of the system to information. The rules, algorithms, and processing routines may classify particular types of information, initiate the collection of additional information, initiate user-intelligible output, and initiate the modification or configuration of environmental elements in the vicinity of the client, or for a combination thereof.

The rules, algorithms, and processing routines may be varied in response to information that pertains specifically to the client or to a user account associated with the client. For example, a visually impaired user may have engaged in a particular course of action that indicates that a departure from the standard action prescribed by the classification would result in a superior user experience. A history of habitually disregarding a particular notification or a particular type of notification may indicate that the user is not interested in the particular notification or type of notification and facilitate suppression of such notifications in the future. In addition, subclassifications may provide for the application of different rules, algorithms, and processing routines within a particular classification.

At 406, the client 101 requests additional information. In some implementations, the process may proceed to 410 or to 412 in the event that the rules, algorithms, and processing routines corresponding to the classification of the client or a user affiliated with the client dictate. The additional information may be requested by the client device 101, by the server 106, or by a combination thereof. The additional information may be stored at the client device 101, at the server 106, or at the database 107. The additional information may include historical actions executed by the client 101 under circumstances similar to those indicated by the information received at 402. The additional information may also include contextual information pertaining to the client. Furthermore, requesting additional information may include providing a prompt to a user that requests that the user provide information to the device. At 408, the client 101 or the server 106 receives the additional information that was requested.

At 410, the client 101, the server 106, or a combination thereof determine an appropriate user-intelligible output to facilitate interaction between the user and the environment in the vicinity of the client 101. In some implementations, the determination of an appropriate user intelligible output is dictated by the rules, algorithms, and processing routines corresponding to the classification of the client 101. The appropriate output may also be determined based upon the information received at 408. In some implementations, a multitude of potentially appropriate user-intelligible outputs may be identified by the client 101 and assigned a score representative of the probability that the output will indeed be appropriate or desired by the user. In order to provide a user with maximum flexibility, the client 101 may provide a user intelligible output that prompts the user to select from a number of actions that are deemed sufficiently probable to facilitate interaction with the environment by the scoring algorithm. At 412, the client 101 provides the user intelligible output determined to be appropriate at 410. In some implementations, the output is provided automatically if the probability that the output will be beneficial exceeds a threshold as determined by the rules, algorithms, and processing routines corresponding to the classification of the client 101.

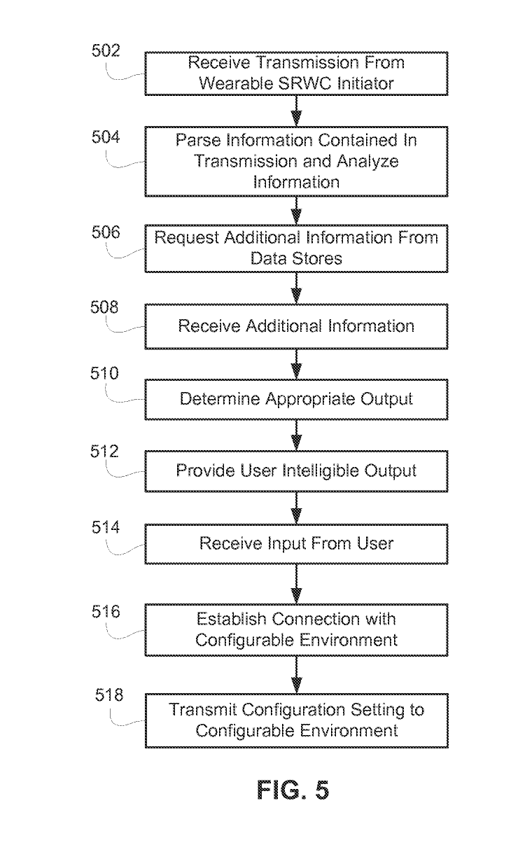

FIG. 5 is a flow diagram illustrating an example method, implemented at a client device, for automatically configuring a user's environment wherein the automatic configuration is triggered by the receipt of data stored at a short range wireless communication target. Elements 502, 504, 506, 508, 510, and 512 correspond to elements 402, 404, 406, 408, 410, and 412 of FIG. 4. However, in FIG. 5, the transmission received from the wearable SRWC initiator at 502 indicates that a configurable environmental element is present in the vicinity of the SRWC initiator 502. Similarly, the process accounts for the presence of the configurable environmental element during the parsing and analysis performed at 504 and during the requesting of additional information from data stores at 506. For example, the analysis at 504 may consider whether or not the configurable environmental element is of interest to the user affiliated with the client 101. The rules, algorithms, and processing routines determined by the impairment classification of the client or a user account affiliated with the client may dictate whether the configurable environmental element is deemed to be of interest to the client. In some implementations, the rules, algorithms, and processing routines may determine a score indicative of the probability that the element is of interest to the user and prescribe particular actions corresponding to particular score ranges.

At 514, the client 101 receives input from the user in response to the output provided at 512. In some implementations, the process may disregard 514 and proceed to 516. The input received from the user 514 may confirm either an interest in configuring the configurable environmental element or a confirm a lack of interest in configuring the configurable environmental element. The input received at 514 may also provide a particular configuration or modification that the user desires to effectuate. For example, the input from the user may indicate an item the user wishes to purchase or an action the user desires to be taken by an appliance, such as brewing a cup of coffee.

At 516, the client 101 establishes a connection with the configurable environmental element. The connection established between the client and the configurable element may be made through a wireless personal area network (WPAN), through a wireless local area network (WLAN), or through an alternative wireless network such as the network 104. At 518, the client transmits a configuration setting to the configurable environmental element. The configuration setting may be developed by the client 101 or the server 106 in response to information received at 502 and information received at 508 or a subset thereof. Alternatively, the configuration setting may be stored at the database 107 or one of the client 101 or the server 106. In some implementations, the information received at 502 includes a uniform resource locator (URL) corresponding to the configurable environmental device and the setting that is transmitted at 518 is predetermined by a user account affiliated with the client 101.

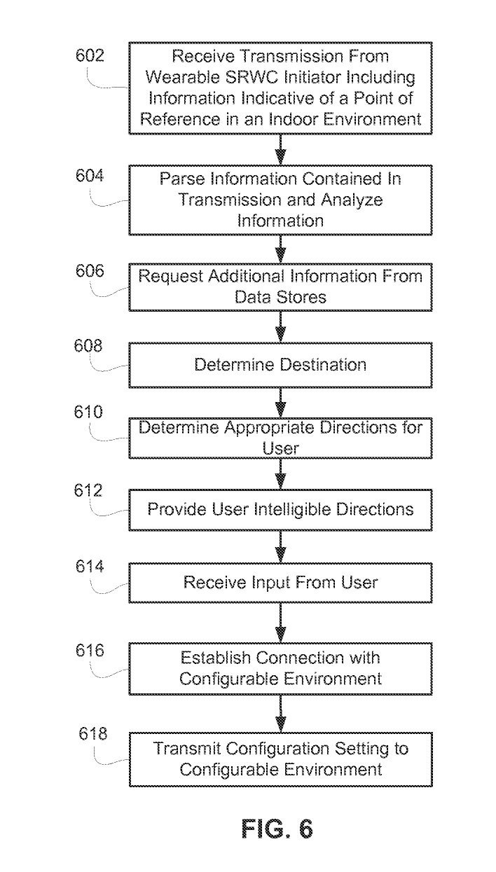

The implementations described in FIGS. 5 and 6 are merely examples and are not intended to limit the scope of the invention in any manner. Functionality performed by particular elements of the systems in the embodiments described in FIGS. 5 and 6 may be performed by alternative elements or distributed across multiple elements in alternative implementations. The inclusion of a particular feature within an embodiment detailed by one of FIGS. 5 and 6 does not imply that the all embodiments of the present invention require such a feature. For example, rules, algorithms, and processing routines may not be defined by classifications based upon impairments. Instead, the rules, algorithms, and processing routines may be determined according to user history or may be static across all users or across classifications not based on impairments.

FIG. 6 is a flow diagram illustrating an example method, implemented at a client device, for providing indoor navigation services to a user. At 602, the client 101 receives a transmission from a wearable SRWC initiator. The transmission received at 602 contains information that identifies a point of reference, i.e. a specific location within a an indoor environment. The point of reference may further correspond to a configurable environmental element. In such case, the transmission received at 602 may contain information pertaining to a manner in which the configurable element may be configured. For example, the transmission received may contain information that the client 101 may utilize to establish a communicative connection with the configurable element. In addition, the transmission received at 602 may include information indicating the location of a resource, such as data pertaining to the layout of an indoor environment and the locations of various reference points and data that can be obtained by an SRWP initiator at such reference points. In some implementations, resources (such as data pertaining to the layout of an indoor environment) may be included in the transmission received from the wearable SRWC initiator. For example, the wearable SRWC initiator may obtain a map of an indoor environment that includes the location of configurable environmental elements within the indoor environment and of reference points that may be used to establish the precise location of a user in the event an SRWC initiator is able to establish a communicative connection with the reference point.

The transmission received at 602 can be triggered by the establishment of an SRWC connection between the SRWC initiator 102B and the target 103. Thus, the transmission received at 602 can be triggered as a result of a wearable SRWC initiator, such as a shoe, a watch, a glove, a ring, etc., being brought into close proximity with an SRWC target embedded in the environment, e.g. a tag, a sticker, a fob, etc. In one embodiment, a user wearing a shoe that includes an SRWC initiator may walk over an SRWC target embedded in the floor at a particular location within a building thereby triggering a transmission from the SWRC initiator to the client 101 that includes information pertaining to the target embedded in the floor. In some such implementations, the embedded target may contain information pertaining to a configurable environmental element, e.g. a speaker, an automatic door, a display screen, etc. The information may comprise a uniform resource locator (URL) that provides a means by which the configurable element may be configured. In such implementations, the SRWC initiator may read the URL from the embedded target and transmit the URL, or data representative of the URL, to the client 101 at 602.

At 604, the client 101 analyzes the information received at 602. In some implementations, the analysis may be performed according to rules, algorithms, and processing routines determined by an impairment classification of the client or of a user account affiliated with the client 101. Such impairment classifications may include but are not limited to visual impairment classes, hearing impairment classes, and mobility impairment classes. For example, the client may utilize a resource indicating the layout of an indoor environment and prepare notifications to be output to the user should the user arrive at other points of reference in the indoor environment where the notifications are determined according to an impairment classification.

The analysis performed at 604 may trigger a request for additional information from data stores that is executed at 606. For example, the analysis performed at 604 may determine a category of indoor environment that corresponds to the information received at 602. The determination of a category of indoor environment may trigger the request of certain types of information from various locations. For example, the determination that an indoor environment is of a retail category may trigger a request for a shopping list from an application executed at the client 101 or at the server 106. The determination that an indoor environment corresponds to a doctor's office may trigger a request for information pertaining to a doctor's appointment from a calendar application residing on the client 101 or the server 106. Furthermore, information pertaining to a user account stored at the database 107 may be requested. Such information may include a history of prior actions executed by the client at the same location or at other locations of the same category and user preferences. Additional contextual information may be requested from a contextual information management application operating at the client 101 or the server 106. Similarly, additional contextual information may be requested by outputting a prompt to a user. At 608, the client 101 receives the requested information.

In some implementations, the analysis performed at 604 may determine that there is insufficient information to specify further action for the client 102 to take. In such implementations, the analysis will trigger a request for additional information at 606. For example, if the analysis performed at 604 determines that the information received at 602 corresponds to an indoor environment, a request for additional information pertaining to the environment may be triggered. Such additional information may include GPS coordinates of the client 102 at the time at which the transmission was received at 602, a list of businesses located within a threshold distance of the indoor environment, a list of events scheduled to take place at the indoor environment during a period of time within a threshold amount of time of the time at which the transmission was received at 602, as well as other types of information. In implementations where the information received at 602 includes an identity of the indoor environment, the analysis performed at 604 may categorized the indoor environment and request additional information at 606 that is determined, at least in part, based on the categorization of the indoor environment. For example, if the indoor environment is categorized as a retail environment, additional information that may determine one or more items of interest (i.e. items a user of the client 102 is likely to be interested in purchasing or learning more about) may be requested from applications executing at the client 102 or the server 106 or from other locations. In addition, additional information may be requested in order to determine specific locations within the indoor retail environment at which the items of interest can be purchased. For example, a user wearing a glove having an SRWC initiator may open the door to a mall and thereby trigger the transmission of data pertaining to the layout of the mall and stored at an SRWC target in the door handle to the client 102. Thereafter, the client may request information from an email application, a to-do-list application, a dialing application, and query information from the internet in order to identify items a user may wish to purchase and the locations within the mall that sell such items.

At 610, the client determines an appropriate user intelligible output based on the information received at 602 and 608. In the embodiment depicted in 610, the appropriate user intelligible output includes directions for assisting a user in reaching a desired destination. In some implementations the desired destination may be inferred from information received at 602 and 608, while in other implementations the desired destination may be determined according to user input. In some implementations, the user-intelligible output is determined according to an impairment classification corresponding to the user device. At 612, the client 101 provides user intelligible output. For example, if the client 101 corresponds to a user with impaired hearing, the device may output visual and tactile output, while if the client 101 corresponds to a user with impaired vision, the device may output aural and tactile output.

At 614, the client 101 detects a deviation from the point of reference indicated in the transmission received at 602. The deviation may be detected based upon information obtained from the motion sensors 290 of the client 101 or based upon information pertaining to the signal strength of various wireless networks. The deviation may also be detected based upon a combination of a variety of mechanisms for detecting motion of the client 101 and the directionality of the detected motion. The directionality of the detected motion can be inferred from the timing of interactions between the client 101 or the SRWC initiator with the environment as well as from a variety of other techniques (e.g. change in triangulation results as a function of time). In some implementations, the algorithms and processing routines utilized to determine the deviation from the point of reference may be dependent upon the point of reference. For example, feedback received from a variety of clients may provide a basis for which the system can determine a best available algorithm for determining a deviation from the point of reference.

At 616, the client 101 outputs additional user intelligible output comprising directions to a destination. At 616, the client 101 may not know its precise location as a result of movement from a point of reference. The client 101 may adjust the format of the output, or may request confirmation that the output is correct in response to determining that the probability that the output was not accurate exceeds a particular threshold.

At 618, the client 101 receives a transmission from a wearable SRWC initiator. The transmission received at 618 contains information that identifies a point of reference, i.e. a specific location within a an indoor environment. The transmission received at 618 may contain any information or type of information received at 602. In some implementations, the client 101 may respond to the transmissions received at 602 or 618 by configuring an element in the indoor environment to provide user intelligible feedback. For example, the client 101 may configure displays located in the indoor environment to display information relevant to the user or configure speakers located in the indoor environment to output information relevant to the user.

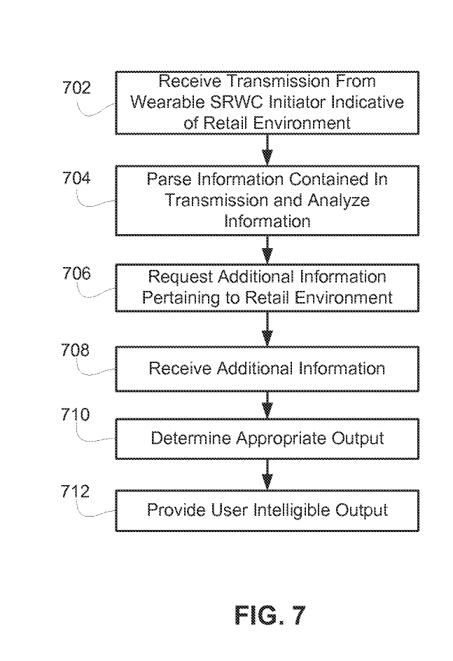

FIG. 7 is a flow diagram illustrating an example method, implemented at a client device, for automatically facilitating interaction between a user and a retail environment. At 702, the client 101 receives a transmission from a wearable SRWC initiator that indicates that the client is present at a retail environment. The transmission received at 702 may contain information that identifies a point of reference, i.e. a specific location within the retail environment. The specific location may further correspond to a configurable environmental element. For example, the location may correspond to a configurable information kiosk that may be configured to provide information pertaining to retail establishments located within the retail environment as well as products offered for sale by such retail establishments. In such case, the transmission received at 702 may contain information pertaining to a manner in which the information kiosk may be configured. For example, the transmission received may contain information that the client 101 may utilize to establish a communicative connection with the information kiosk, such as a uniform resource locator (URL), that enables configuration of the kiosk. In addition, the transmission received at 702 may include information indicating the location of a resource, such as data pertaining to the layout of the retail environment and the locations of various reference points and data that can be obtained by an SRWP initiator at such reference points. In some implementations, resources (such as data pertaining to the layout of an indoor environment) may be included in the transmission from a wearable SRWC initiator. For example, the wearable SRWC initiator may obtain a map of the retail environment that includes the location of certain products and other points of interest.

At 704, the client 101 analyzes the information received at 702. In some implementations, the analysis may be performed according to rules, algorithms, and processing routines determined by an impairment classification of the client or user account affiliated with the client 101. Such impairment classifications may include but are not limited to visual impairment classes, hearing impairment classes, and mobility impairment classes. For example, the client may utilize a resource indicating the layout of an indoor environment and prepare notifications to be output to the user should the user arrive at other points of reference in the indoor environment where the notifications are determined according to an impairment classification.

The analysis performed at 704 may trigger a request for additional information from data stores that is executed at 706. For example, the analysis performed at 704 may determine a category of retail environment that corresponds to the information received at 702 and request information from email applications, calendar applications, shopping list applications, and other applications as well as prior user interactions at the retail environment or similarly classified retail establishments. The identification of an item of potential interest to the customer may trigger a request for information pertaining to the product and locations within the retail environment where the user can acquire the product.

At 710, the client determines an appropriate user intelligible output based on the information received at 702 and 708. In the embodiment depicted in 710, the appropriate user intelligible output may include directions for assisting a user in acquiring items on a shopping list, queries pertaining to items the user would like to purchase or acquire information about, or other types of interaction the user may wish to have with the retail environment. At 712, the client 101 provides user intelligible output. For example, if the client 101 corresponds to a user with impaired hearing, the device may output visual and tactile output, while if the client 101 corresponds to a user with impaired vision, the device may output aural and tactile output. The user-intelligible output may include prices of items, information pertaining to particular items, directions to points of sale where the user can acquire particular items, and additional information pertaining to the retail environment.

The process outlined in FIG. 7 may be used in a variety of contexts and may be practiced in a manner where certain steps are repeated and performed in an order not adhering to the order listed in FIG. 7. For example, a user wearing a wearable SRWC initiator, such as a glove, a watch, or a ring, may select a shopping cart equipped with a SRWC target and a network interface capable of communicating with the client 101. The user may facilitate the establishment of an SRWC connection between the shopping cart and the wearable SRWC initiator by pulling the shopping cart from a shopping cart storage area. The establishment of the SRWC connection may trigger the transmission of information pertaining to the shopping cart, e.g. a shopping cart ID and data allowing the client to establish a communicative connection with the shopping cart and configure the shopping cart according to the user's preferences (if the shopping cart is configurable). For example, the client 101 may establish a merchandise tracking routine with the shopping cart. In such an implementation, the wearable SRWC initiator may subsequently establish an SRWC connection with an SRWC target, such as a sticker, attached to an item of merchandise. The establishment of such a connection would trigger information pertaining to the item of merchandise being transferred to the client. Thereafter, the client and shopping cart might verify that the particular piece of merchandise was placed into the shopping cart through communications that may include, e.g., merchandise weight verification.

It is contemplated that other implementations may differ in detail from the foregoing examples. As such, all references are intended to reference the particular implementation being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to retrieve content from a content server. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as, for example, to a city, ZIP code, or state level), so that a particular location of a user cannot be determined. Thus, the user may have control over how information is collected about him or her and used by the systems discussed herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Variations of the embodiments disclosed herein may become apparent to those of ordinary skill in the art upon reading the foregoing description. Skilled artisans may employ such variations as appropriate, and the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for providing a user-intelligible output in response to information representative of environmental surroundings, the system comprising:
a wearable short-range wireless communication (SRWC) initiator, configured to:
acquire, via SRWC, information representative of environmental surroundings, and
transmit the acquired information representative of the environmental surroundings; and
a client device comprising a processor configured to:
receive the acquired information representative of the environmental surroundings,
analyze the information representative of the physical surroundings, and
initiate a user-intelligible output in response to the analyzing.

2. The system of claim 1, further comprising:
an environmental element configurable by the client device;
wherein the SRWC initiator is further configured to acquire information pertaining to the configurable environmental element, and
wherein the client device is further configured to initiate the configuration of the configurable environmental element.

3. The system of claim 1, wherein the analyzing is based on processing routines corresponding to a class associated with the user of the client device.

4. The system of claim 3, wherein the class is indicative of a category of user impairment.

5. The system of claim 3, wherein the class is one of the group consisting of: visual impairment, hearing impairment, and mobility impairment.

6. The system of claim 1, wherein the client device is further configured to acquire information representative of the context of the client device, wherein the information representative of the context of the client is acquired from one of the group consisting of: a server, a database, and the client.

7. The system of claim 1, wherein the acquired information representative of physical surroundings of the client device comprises acquiring information indicative of a point of reference defined with respect to an indoor environment.

8. The system of claim 7, wherein the information representative of physical surroundings comprises data representative of the physical layout of an indoor environment.

9. The system of claim 8, wherein the user-intelligible output comprises directions to aid a user in reaching a desired destination.

10. A method for providing a response to surroundings of a client device, the method comprising:
acquiring, at the client device, information representative of the surroundings of the client device;
analyzing, at the client device, the information representative of the surroundings; and
initiating, at the client device, a user-intelligible output responsive to the analyzing;
wherein a potion of the information representative of the surroundings of the client device is transmitted to the client device by a wearable short-range wireless communication (SRWC) initiator, and
wherein the analyzing determines the characteristics of the output.

11. The method of claim 10, further comprising:
acquiring, at the client device, information pertaining to a configurable environmental element; and
initiating configuration of the configurable environmental element;
wherein a portion of the information pertaining to a configurable environmental element is transmitted to the client device by the wearable SRWC initiator.

12. The method of claim 10, wherein the analyzing is based on processing routines corresponding to a representative class to which the client device belongs.

13. The method of claim 12, wherein the representative class is indicative of a category of user impairment.

14. The method of claim 13, wherein the class is one of the group consisting of: visual impairment, hearing impairment, and mobility impairment.

15. The method of claim 10, wherein the acquiring information representative of the surroundings of the client device comprises acquiring information indicative of a point of reference with respect to an indoor space.

16. The method of claim 10, wherein the information representative of the surroundings comprises information regarding the physical layout of an indoor space.

17. A client device, comprising:
a network interface configured to receive information representative of the surroundings of the client device; and
a processor, configured to analyze the information representative of the surroundings of the client device and to initiate a user-intelligible output responsive to the analyzing.

18. The client device of claim 17, wherein the network interface is further configured to receive information pertaining to a configurable environmental element and to transmit configuration information to the configurable environmental element.

19. The client device of claim 18, wherein the analyzing the information representative of the surroundings of the client device and the initiating a user-intelligible output responsive to the analyzing are based on processing routines corresponding to a representative class to which the client device belongs.

20. The client device of claim 17, wherein the network interface is configured to receive information representative of the surroundings of the client device from a short-range wireless communication (SRWC) initiator.
